(19) United States
(12) Patent Application Publication
(10) Pub. No.: US 2009/0210456 A1
(43) Pub. Date: Aug. 20, 2009

(54) Methods, Systems and Media for TPM Recovery Key Backup and Restoration

(75) Inventor: Narayanan Subramaniam, Bangalore (IN)

Correspondence Address: ANDREA E. TRAN;PRAMUDJI WENDT & TRAN, LLP, 1800 BERING DRIVE, SUITE 540, HOUSTON, TX, 77057, US

(73) Assignee: DELL PRODUCTS L.P., Round Rock, TX (US)

(21) Appl. No.: 12/032,824

(22) Filed: Feb. 18, 2008

(51) Int. Cl. G06F 17/30

(52) U.S. Cl. 707/202; 707/E17.007

(57) ABSTRACT

A method of trusted platform module (TPM) activation and recovery in an information handling system (IHS). The method includes providing a first virtual recording medium associated with a first recording medium, wherein the first recording medium is coupled to a management console. Further, a TPM recovery key is stored on the first virtual recording medium.

### BACKGROUND

1. Technical Field

The present disclosure relates generally to the field of information handling systems. More specifically, but without limitation, the present disclosure relates to backup and recovery of a trusted platform module (TPM).

2. Background Information

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for such systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Within an information handling system (IHS), a trusted platform module (TPM) may be incorporated into an IHS and used to perform trusted computing operations. A TPM is a microcontroller or chip developed by the Trusted Computing Group (TCG) that may store and manage secured data such as cryptographic keys. Operation of a TPM is outlined in the TPM specification (i.e. TPM Main Part 1 Design Principles, Specification Version 1.2, Level 2 Revision 103, TCG, 2007), which is herein incorporated by reference. The TPM may store data indicating the configuration of the IHS. In some cases, configuration data may used by the TPM to prevent a different IHS or device from accessing keys stored by a TPM. Loss of cryptographic keys on a TPM may result in an inability to access data, operations, application or the like on an IHS.

One of the trusted computing operations that a TPM may be used for in certain modes of operation is BitLocker. BitLocker is a data protection feature developed by Microsoft which provides full disk encryption for entire volumes of a disk. BitLocker may use a TPM to generate keys to encrypt a volume of a disk to prevent unauthorized access. In one mode of operation, BitLocker uses public/private keys generated by a TPM to encrypt data stored on a hard drive. BitLocker protects confidential information stored on IHSs when they are lost, stolen, inappropriately decommissioned, accessed without authorization or the like. BitLocker may also use a TPM to verify the integrity of early boot components and boot configuration data to ensure that BitLocker encrypted volumes are accessible only if an IHS has not been altered and the encrypted drive is in the original IHS.

However, as a consequence of using TPM chips, it is essential to securely back up a TPM recovery key. A TPM recovery key may store data on a recording medium which allows recovery of data on a TPM including cryptographic keys. Data on a TPM chip may be lost when there is a motherboard failure or when there are changes to code executed when an IHS is booted (e.g. a core root of trust measurement (CRTM)). For example, an application key and hash value data stored by a TPM may be lost when hardware fails (e.g. motherboard) or when a master boot record (MBR), BIOS update, hardware configuration changes or the like cause a change in a core root of trust measurement (CRTM). If data on the TPM chip is lost, data on the encrypted hard drive cannot be retrieved without the keys generated by the TPM.

A TPM recovery key stored on a removable USB key may be used to recover TPM data. However, in a data center environment, this practice may not be practical. It would be difficult for an administrator to be present at every device during a mass scale activation of TPMs in a data center or during TPM recovery procedures. Further, placing a TPM recovery key on a USB key at the same location as an IHS is not recommended for security reasons.

Thus a need remains for methods, systems, and apparatus for remotely backing up and accessing a TPM recovery key.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

One aspect of the disclosure provides a method of trusted platform module (TPM) activation and recovery in an information handling system (IHS), the method including providing a first virtual recording medium associated with a first recording medium, wherein the first recording medium is coupled to a management console and storing a TPM recovery key on the first virtual recording medium.

Another aspect of the disclosure provides an information handling system (IHS) including a management console comprising a first recording medium and a first virtual recording medium associated with the first recording medium, wherein the first virtual recording medium stores a trusted platform module (TPM) recovery key.

Yet another aspect of the disclosure provides a computer-readable medium having executable instructions for performing a method including creating a first virtual recording medium corresponding to a first recording medium, wherein the first recording medium is coupled to a management console and saving a trusted platform module (TPM) recovery key to the first virtual recording medium.

Yet another illustrative aspect of the disclosure provides an IHS including a first managed node, wherein the first managed node is coupled to a first virtual recording medium via an interface. The first managed node includes a trusted platform module (TPM), wherein the TPM is enabled through an operating system interface and a TPM recovery key stored to the first virtual recording medium.

### BRIEF DESCRIPTION OF THE DRAWINGS

For detailed understanding of the present disclosure, references should be made to the following detailed description of the several aspects, taken in conjunction with the accompanying drawings, in which like elements have been given like numerals and wherein:

FIG. 1 represents an illustrative information handling system according to the present disclosure;

FIG. 2 depicts an illustrative implementation of a data center;

FIG. 3 represents an illustrative implementation of a trusted platform module (TPM) backup and recovery system;

FIG. 4 provides a flow diagram of an illustrative method for TPM activation; and

FIG. 5 is a flow diagram of an illustrative method for restoring a TPM recovery key.

### DETAILED DESCRIPTION

Although the invention may be described with reference to specific implementations, it will be understood by those skilled in the art that various changes may be made without departing from the spirit or scope of the invention. Various examples of such changes have been given in the forgoing description. Accordingly, the disclosure of particular implementations is intended to be illustrative of the scope of the invention and is not intended to be limiting. It is intended that the scope of the invention shall be limited only to the extent required by the appended claims. For example, to one of ordinary skill in the art, it will be readily apparent that the information handling system discussed herein may be implemented in a variety of implementations, and that the forgoing discussion of certain of these implementations does not necessarily represent a complete description of all possible implementations. For simplicity and clarity of illustration, the drawing and/or figures illustrate the general manner of construction, and descriptions and details of well known features and techniques may be omitted to avoid unnecessarily obscuring the disclosure.

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

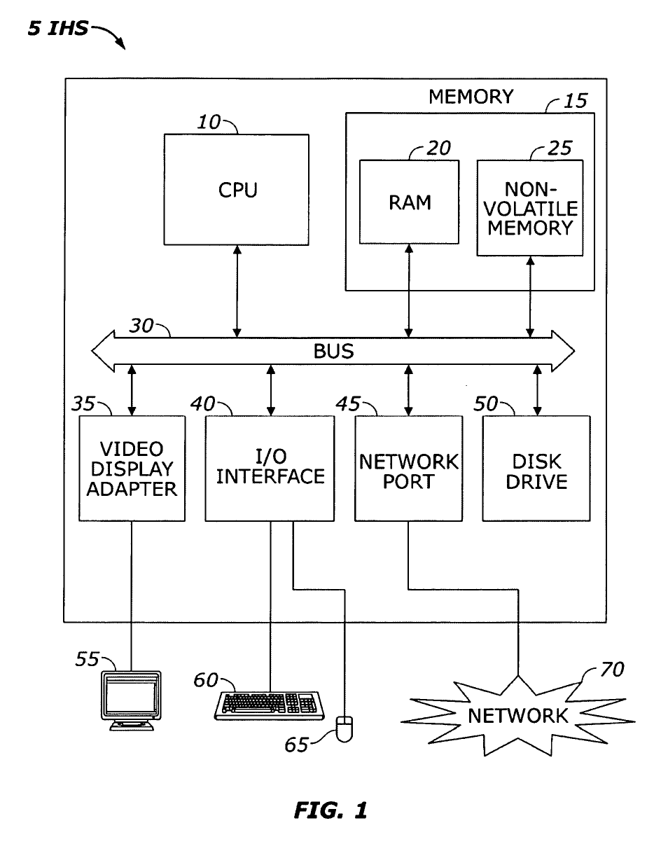

FIG. 1 illustrates one possible implementation of an IHS 5 comprising a CPU 10. It should be understood that the present disclosure has applicability to information handling systems as broadly described above, and is not intended to be limited to the IHS 5 as specifically described. The CPU 10 may comprise a processor, a microprocessor, minicomputer, or any other suitable device, including combinations and/or a plurality thereof, for executing programmed instructions. The CPU 10 may be in data communication over a local interface bus 30 with components including memory 15 and input/output interfaces 40. The memory 15, as illustrated, may include non-volatile memory 25. The non-volatile memory 25 may include, but is not limited to, firmware flash memory and electrically erasable programmable read-only memory (EEPROM). The firmware program (not shown) may contain, programming and/or executable instructions required to control a keyboard 60, mouse 65, video display 55 and/or other input/output devices not shown here. The memory may also comprise RAM 20. The operating system and application programs may be loaded into the RAM 20 for execution.

The IHS 5 may be implemented with a network port 45 to permit communication over a network 70 such as a local area network (LAN) or a wide area network (WAN), such as the Internet. As understood by those skilled in the art, IHS 5 implementations may also include an assortment of ports and interfaces for different peripherals and components, such as video display adapters 35, disk drives port 50, and input/output interfaces 40 (e.g., keyboard 60, mouse 65).

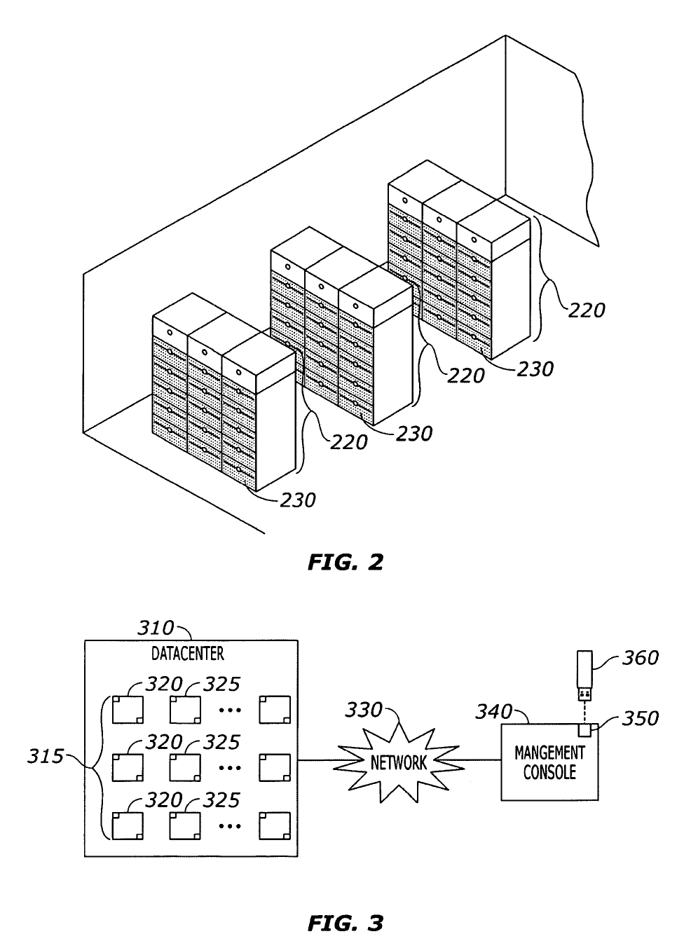

FIG. 2 depicts an illustrative implementation of a data center. A data center 200 may have one or multiple racks 220 containing servers, routers, switches, and other computing equipment 230. Within a network, there may be several data centers and each data center may be at a different location.

FIG. 3 represents an illustrative implementation of a trusted platform module (TPM) backup and recovery system. In a TPM backup and recovery system, one or more data center 310, such as a data center shown in FIG. 2, may be coupled to a management console 340 through a network 330 (to be discussed below). A data center 310 may have a plurality of managed nodes 315. A node 315 may be any device that can be connected to a network or a point at which network lines branch. Nodes or managed nodes may be configured, modified, controlled and the like by a management console 340. By way of example, each node 315 may have a remote access card (RAC), baseband management controller (BMC), or the like 320 for configuring, modifying, controlling and the like a managed node 315. A RAC or BMC 320 may allow an administrator or the like to remotely access a node 315. For example, an administrator may remotely reconfigure or make changes to a node's settings from a management console 340 using a remote access card 320. Additionally, each node 315 may also include a TPM 325.

A TPM chip 325 is a microcontroller that may store secure information. In order to ensure trusted computing, one may verify the integrity of an IHS using a TPM. For example, certain root of trust components must be trusted because misconduct may not be detected. A complete set of root of trust may function to describe platform characteristics that affect trustworthiness. The core root of trust measurement (CRTM) may perform integrity measurements. For example, the CRTM may be a BIOS boot block code that reliably measures value of other entities (e.g. applications or hardware), and stays unchanged during the lifetime of an IHS. A BIOS boot block code may run when an IHS is booted and check values of entities. Any changes to these values may affect the trustworthiness of an IHS.

In an IHS with a TPM, the IHS may perform in a similar manner as an IHS without a TPM. In order to perform trusted computing operations, a TPM should be enabled. A user may enable a TPM using an operating system to enable a TPM. For example, an operating system such as Windows Vista may have a TPM initialization wizard or the like. This allows a user to set up a level of security he desires by selecting TPM settings and trusted computing operations he wishes to have an IHS perform.

A user or administrator may need to enable several TPMs for devices in a network, including several devices at one or more data centers. For example, an administrator may need to be present to store a TPM recovery key on a USB key. However, storing a TPM recovery key on a USB key may not be practical in a data center environment. If there are hundreds of TPMs that need to be enabled at several different locations, it would be difficult for an administrator to be physically present at every device. A mass scale activation of TPMs may prove to be excessively time consuming. Further, keeping a USB key used to store a TPM recovery key at the same location as the device may not be recommended. If a device is stolen, a TPM recovery key may also be taken as well.

A management console 340 may have a USB key 360 and USB port 350. An administrator may provide a USB key 360 as a virtual USB device for a managed node 315. For example, a RAC virtual media command line interface (VM-CLI) may be used to attach a USB key 360 as a virtual USB device to a managed node 315. By attaching a remotely located USB key 360 as a virtual USB device to a managed node 315, the managed node 315 performs as if the USB key is actually present at the managed node 315. In another implementation, a different recording medium such as a floppy disk, a memory card, a CD, a DVD, or the like may be used in place of a USB key. An administrator may save a TPM recovery key to the virtual USB device, which is a USB key 360 located at a management console 340. At least one TPM 325 may be activated from a management console 340, and the TPM recovery keys for each device may be stored at a management console 340. TPM recovery keys for each managed node 315 may be stored in separate compartments of a management console 340, such as folders or directories. Folders or directories may be named based on a managed node's chassis identification or module service tag or by any other suitable alternative. In another implementation, TPM recovery keys may be stored at a location other than the location of the management console 340. By allowing an administrator to remotely store TPM recovery keys, an administrator may not need to be physically present at a managed node to enable a TPM.

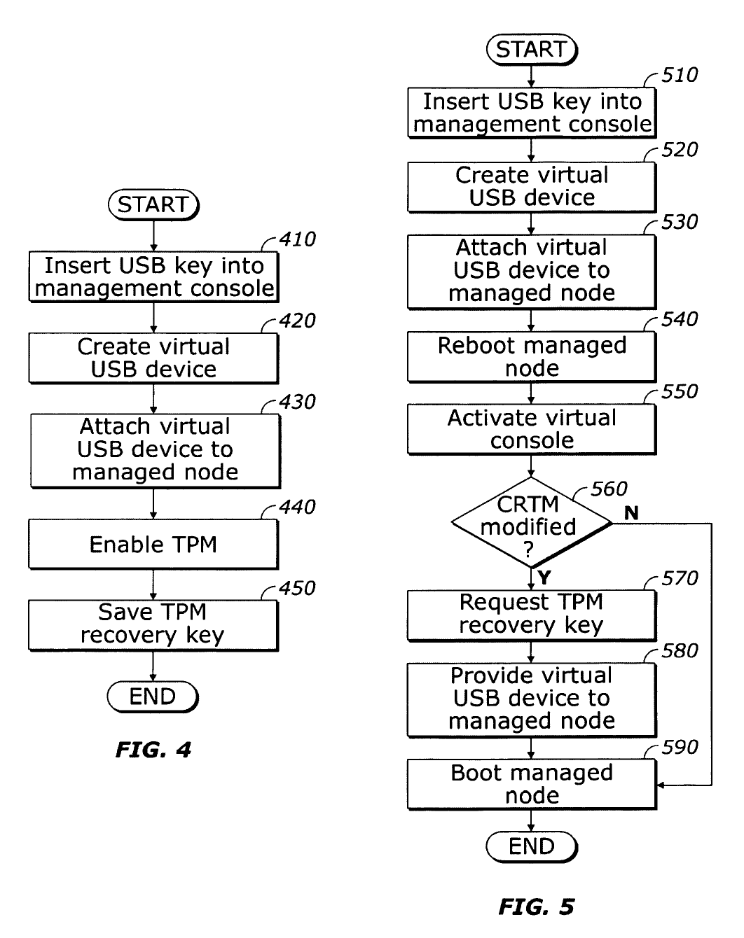

FIG. 4 provides a flow diagram of an illustrative method for TPM activation. Various methods are contemplated including all or less than all of the steps shown in methods described herein and/or mentioned below, any number of repeats or any of the steps shown and/or mentioned below, and in any order. An administrator may start TPM activation in step 410 by inserting a USB key in a management console. An administrator may then create a USB virtual device for a managed node in step 420. As used herein, a managed node may refer to a node coupled to a management console. A USB key at a management console may be attached as a virtual USB device for a managed node in step 430. This may be done using a RAC, a BMC, or using any other suitable method. Next, an administrator enables a TPM in step 440. A TPM may be enabled using an operating system interface, a BIOS interface, a tool deployed with a managed node or any other suitable method. For example, an administrator may access a node using a windows management instrumentation (WMI) interface or the like to enable a TPM. Once a TPM is activated, an administrator may save a TPM recovery key onto a virtual USB device in step 450 using a WMI interface or the like. Since the virtual USB device may actually be a USB key at a management console, a TPM recovery key may be stored remotely at the management console. A separate compartment, directory, folder, or the like may be created for each managed node to store a TPM recovery key. For example, a folder may be named according to a chassis or module service tag of a managed node or according to any other suitable method.

In another implementation, an administrator may attach a different storage medium as a virtual USB device or an administrator may attach a storage medium at a location other than the location of a management console as a virtual USB device. Further, each step may be performed on a mass scale to allow an administrator to activate several TPMs. For example, activation of TPMs may be scripted using WMI with extensions to save TPM recovery keys on a USB device. This may allow an administrator to enable several TPMs remotely at nearly the same time using a scripted program or the enablement of several TPMs on a 1:n scale via WMI interfaces.

FIG. 5 illustrates a method for restoring a TPM recovery key. A USB key may be inserted in a management console by an administrator in step 510. In step 520, an administrator may create a virtual USB device. A USB key located at a management console may then be attached to a managed node as a virtual USB device in step 530. A managed node may be rebooted in step 540, and an administrator may activate a virtual console in step 550. A virtual console may create a virtual device corresponding to hardware or software. The virtual device may then be attached or plugged in to a device such as a node. For example, a virtual console on a management console may be used to create a virtual USB device to be attached to a node. In another implementation, a virtual console may be activated while a node is rebooted. An administrator may reboot a node and activate a virtual console from a management console using a RAC, BMC, or any other suitable method.

Once a node has been rebooted, a check may be performed to determine if a core root of trust measurement (CRTM) has been modified in step 560. A change to a CRTM may occur because of a hardware failure, changes to a master boot record, a BIOS update, changes to hardware configuration, or the like. In another implementation, some applications or operations may check a CRTM before allowing a user access to the application or operation. For example, BitLocker may check for changes to the CRTM before allowing a user access to encrypted data. If a CRTM has not been modified, then the managed node may be booted in step 590 If a CRTM has been modified, then a node may request a TPM recovery key in step 570. A node may make a request at a USB key for a TPM recovery key. An administrator may locate and provide a TPM recovery key corresponding to a node's request as a virtual USB key to a node in step 580. Further, a new CRTM may also be set in a TPM so that subsequent boots do not require a TPM recovery key. Once A TPM recovery key is provided to a node, the node may booted in step 590.

By backing up TPM recovery keys using a RAC or BMC as a virtual media interface, remotely located USB keys may be used to backup TPM recovery keys. This provides an alternative to storing TPM recovery keys locally on a USB key, floppy disk, or CD. Additionally, applications or operations can recover a TPM key remotely using a virtual USB device to access a TPM recovery key. This provides a mass scale management solution for activation and recovery of a TPM. TPM recovery keys can be saved to, restored from and organized for each node.

Methods of the present disclosure, detailed description and claims may be presented in terms of logic, software or software implemented aspects typically encoded on a variety of media or medium including, but not limited to, computer-readable medium/media, machine-readable medium/media, program storage medium/media or computer program product. Such media may be handled, read, sensed and/or interpreted by an IHS (IHS). Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). It should be understood that the given implementations are illustrative only and shall not limit the present disclosure.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, and/or use of equivalent functional junctions for couplings/links described herein.

What is claimed is:

1. A method of trusted platform module (TPM) activation and recovery in an information handling system (IHS), the method comprising:
providing a first virtual recording medium associated with a first recording medium, wherein the first recording medium is coupled to a management console; and
storing a TPM recovery key on the first virtual recording medium.

2. The method of claim 1, wherein the first virtual recording medium is coupled to a first managed node from the management console via an interface, and the management console remotely enables a TPM.

3. The method of claim 2 further comprising:
activating a virtual console, wherein the management console further comprises the virtual console; and
sending the TPM recovery key to the first managed node from the first virtual recording medium and rebooting the first managed node from the management console when a core root of trust measurement (CRTM) is modified.

4. The method of claim 3 further comprising:
recovering a first key used to encrypt data stored on a hard drive in the first managed node, wherein the TPM recovery key is used to recover the first key; and
decrypting the data stored on the hard drive utilizing the first key.

5. The method of claim 4, wherein the hard drive is encrypted using BitLocker.

6. An information handling system comprising:
a management console comprising:
a first recording medium; and
a first virtual recording medium associated with the first recording medium, wherein the first virtual recording medium stores a trusted platform module (TPM) recovery key.

7. The system of claim 6 further comprising:
a first managed node, wherein the first virtual recording medium is coupled to the first managed node by the management console via an interface, and the first managed node comprises:
a TPM contained in the first managed node, wherein the TPM is enabled from the management console.

8. The system of claim 6, wherein a management console further comprises a virtual console that is activated, and the management console reboots the first managed node and sends the TPM recovery key on the first virtual recording medium to the first managed node when a core root of trust measurement (CRTM) is modified.

9. The system of claim 8, wherein the first managed node recovers a first key used to encrypt a hard drive in the first managed node by using the TPM recovery key, and the hard drive is decrypted with the first key.

10. The system of claim 9, wherein the hard drive is encrypted using BitLocker.

11. A computer-readable medium having executable instructions for performing a method comprising:
creating a first virtual recording medium corresponding to a first recording medium, wherein the first recording medium is coupled to a management console; and
saving a trusted platform module (TPM) recovery key to the first virtual recording medium.

12. The computer-readable medium of claim 11, wherein the first virtual recording medium is coupled to a first managed node from the management console via an interface, and the management console remotely enables a trusted platform module (TPM).

13. The computer-readable medium of claim 12 further comprising:
activating a virtual console; and
sending the TPM recovery key to the first managed node from the first virtual recording medium and rebooting the first managed node from the management console when a core root of trust measurement (CRTM) is modified

14. The computer-readable medium of claim 13 further comprising:
recovering a first key used to encrypt a hard drive, wherein the TPM recovery key is used to recover the first key; and
decrypting the hard drive with the first key.

15. The computer-readable medium of claim 14, wherein the hard drive is encrypted using BitLocker.

16. An information handling system comprising:
a first managed node, wherein the first managed node is coupled to a first virtual recording medium via an interface, and the first managed node comprises:
a trusted platform module (TPM), wherein the TPM is enabled remotely through an interface; and
a TPM recovery key stored to the first virtual recording medium.

17. The system of claim 16 further comprising:
a management console comprising a first recording medium, wherein the first recording medium is associated with the first virtual recording medium.

18. The system of claim 17, wherein a management console further comprises a virtual console that is activated, and the management console reboots the first managed node and sends the TPM recovery key on the first virtual recording medium to the first managed node when a core root of trust measurement (CRTM) is modified.

19. The system of claim 18, wherein the first managed node recovers a first key used to encrypt a hard drive by using the TPM recovery key, and the hard drive is decrypted with the first key.

20. The system of claim 19, wherein the hard drive is encrypted using BitLocker.
